(19) United States
(12) Patent Application Publication
(10) Pub. No.: US 2007/0179230 A1
(43) Pub. Date: Aug. 2, 2007

(54) PACKAGING MATERIAL HAVING A NONSTICK COMPOSITION AND USE THEREOF FOR PACKAGING FOODS

(75) Inventors: Bernd SPERLICH, Walsrode (DE); Willi SCHWARZ, Bomlitz (DE); Hans WUNDERLICH, Bomlitz (DE)

Correspondence Address: FOLEY AND LARDNER LLP;SUITE 500, 3000 K STREET NW, WASHINGTON, DC, 20007, US

(73) Assignee: WIPAK Walothen GmbH

(21) Appl. No.: 11/623,673

(22) Filed: Jan. 16, 2007

(30) Foreign Application Priority Data
Jan. 13, 2006 (DE) 10 2006 001 752.8

(51) Int. Cl. C08K 5/10

(52) U.S. Cl. 524/315; 428/411.1

(57) ABSTRACT

To prevent packaging materials made of thermoplastic polymers from adhering to pasty and fatty foods, a nonstick composition comprising a fatty acid ester of a polyhydric alcohol having at least one fatty acid radical per ester molecule with 19 or more carbon atoms is incorporated into at least one selected area of a polymer packaging material. Even if included only in surface-close regions or layers of the packaging material, a permanent nonstick effect is observed.

### CROSS-REFERENCE TO RELATED PATENT APPLICATIONS

The right of foreign priority is claimed under 35 U.S.C. §119(a) based on Federal Republic of Germany Application No. 10 2006 001 752.8, filed Jan. 13, 2006, the entire contents of which, including the specification, drawings, claims and abstract, are incorporated herein by reference.

### BACKGROUND OF THE INVENTION

The invention relates to a packaging material made of thermoplastic polymer in the form of films, webs, sheets, troughs or other fabricated forms, in particular for packaging foods and also associated packages. The invention also relates to the use of esters of fatty acids for formulating a nonstick composition in such packages and materials.

Plastic films and packages are very frequently in direct contact with foods. Some foods, in particular fatty and pasty foods, have a tendency to stick to the packaging surface. This effect becomes stronger when the food was charged into the packaging in the hot and liquid state. The food can then only be removed from the packaging with difficulty. It would therefore be desirable to be able to avoid having the food product adhere to the packaging.

EP 1 362 792 discloses finishing plastic food packages in such a manner that adhesion of cheese, processed cheese, peanut butter, cheese spread, dressings, gelatin products and dairy products is very largely prevented. For this, glycerol monostearate (GMS) is added to the plastic, that is at least to the plastic compositions forming the inner container surface, in an amount of at least 4000 ppm. The additive is said to decrease the adhesion to the food, in particular cheese and processed cheese (nonstick agent).

However, it has been found that the additive glycerol monostearate can be extracted from the plastic. As is also known for other additives, inter alia, for plasticizers, the glycerol monostearate migrates with time (during storage) out of the packaging into the packaged material, for example, a food.

Owing to the migration of the GMS, the desired action is lost, since the packaging surface becomes deficient in additive. Product stored for a relatively long time, for this reason, will adhere more strongly to the packaging.

Glycerol monostearate is a monoester of glycerol with stearic acid, an unbranched C18 fatty acid. The substance is used as an emulsifier in the food industry, inter alia, for fatty dough masses, ice cream, instant potato products and the like, and must be declared as E 471. Despite this permission, it is obviously not desirable that plastic additives can be detected in the packaged material.

### SUMMARY OF THE INVENTION

One general object therefore underlying the invention is to prevent as effectively as possible, and preferably permanently, the adhesion of fatty and especially pasty food products to plastic packages made of thermoplastic polymers in contact with them.

In accomplishing this object, a packaging material made of thermoplastic polymer is provided which comprises a content at least in one selected region in the polymeric material of a fatty acid ester of a polyhydric alcohol, wherein at least one fatty acid radical per ester molecule has 19 carbon atoms or more.

There is also provided according to the invention a method of incorporating a fatty acid ester of a polyhydric alcohol, having at least one fatty acid radical per ester molecule with 19 carbon atoms or more, into at least one selected region of a packaging material made of thermoplastic polymer, to serve as nonstick additive to produce a nonstick composition.

Also provided according to the invention is a packaged food product.

Further objects, features and advantages of the invention will become apparent from the detailed description of preferred embodiments that follows.

### DETAILED DESCRIPTION OF THE PREFERRED EMBODIMENTS

Surprisingly, it has been found that even a small increase in chain length in the fatty acid radical of the ester additive leads to an abrupt absolute improvement of the adhesion reduction. This has been experimentally verified.

By using polyol esters having a relatively long chain length of the fatty acid component, the above-described adverse storage effect can be avoided. Surprisingly, the adhesion of the food or of the fatty or pasty packaged material to the packaging becomes even lower with storage time. The reason for this effect has not yet been explained. Further, it has been found that, in the case of esters with relatively long chain fatty acid radicals (from C19), a lower amount of additive is required.

The additive which is to prevent the adhesion of the packaged foods to the packaging (nonstick composition) according to the invention is a fatty acid ester of a polyhydric alcohol, that is a mono-, di- or if appropriate triester of a mono-, di- or triol. Preference is given to use of the monoester, in particular of glycerol or of glycol. The fatty acid radical preferably has at least 19 carbon atoms, that is nonadecanate or higher. In preferred embodiments, the esters with C20 to C30 fatty acid radicals are provided, further preferably C20 to C26. Especially preferred embodiments include arachinate (C20), behenate (C22), lignocerate (C24) and cerotinate (C26). Currently particular preference is given to glycerol monobehenate.

The active amount in which the fatty acid ester is to be used for the desired activity can be determined by experiment. It has been concluded from previous experiments that concentrations greater than or equal to 200 ppm already express activity. For reliable activity, even in the case of foods adhering relatively strongly to the packaging, concentrations greater than or equal to 500 ppm, or preferably greater than or equal to 800 ppm are preferred.

If the packaging comprises a uniform material, which can be the case, for example, for simple plastic containers or single-layer films, the fatty acid ester can be homogeneously distributed throughout the packaging material. However, it is also possible to introduce the additive only into regions selected for expression of the anti-stick activity, or layers of the packaging selected for expression of this activity. These regions or layers are preferably those which come into contact with the packaged material, or alternatively those that lie directly below the surfaces that face the packaged material.

When the remaining parts of the packaging or the packaging material do not contain the ester, but only regions or layers selected for expression of anti-stick activity, the additive can be used in relatively economical amounts. Also, it is then possible to use standard compositions which do not contain fatty acid ester for certain other layers or packaging regions.

The packaging material can, according to another embodiment of the invention, be a film, in particular a multilayer film, made of thermoplastic polymers, as used, for example, for individual wrapping of cheese slices. The packaging material can also be designed as a more rigid material, as serves for the production of troughs or any other desired containers. The material in total, or the layers of a film, can preferably be comprised of polyolefins, in particular polyethylene or polypropylene; polyesters; polystyrene; polyamide; or copolymers with or among the abovementioned substances or mixtures based on these polymers. Suitable packaging materials, including films and multilayer films which can be modified by the inventive fatty acid ester additive for adhesion reduction, are known in principle to those skilled in the art.

In one embodiment, the fatty acid ester can be contained in at least one outer layer of a multilayer film. Generally, the use of the ester in one outer layer is sufficient. This outer layer is then faced to the filling during the packaging operation. The outer layer in which the fatty acid ester additive is contained can be a sealing layer. To enable use of the film on both sides, or for films which are to serve as separation sheets between foods, the fatty acid ester can also be present in both outer layers of the film, in each case in the desired concentration.

In a further embodiment, the fatty acid ester can be arranged in a layer beneath one or more covering layers, which preferably are of no more than 20 μm in total thickness. The covering layer can be, for example, a heat-sealable coating or a multilayer heat-sealable barrier coating.

The layer containing the fatty acid ester additive can preferably be a polyethylene-, polypropylene-, polyester- or polyamide-based layer. “Based” means here, as known to those skilled in the art, the fact that other polymers or copolymers and further additives can be present in a minor amount.

In a preferred embodiment, the film is a stretched or partially stretched film, that is a mono- or biaxially oriented (BO) film, for example, a BOPP, BOPE or BOPET film.

For the more rigid materials for producing troughs or containers, use is preferably made of the same base materials, that is principally polyolefins, in particular polyethylene or polypropylene, polyester, polystyrene, polyamide, copolymers with or among the abovementioned substances or mixtures based on these polymers. Also, here, the fatty acid ester can preferably be introduced into a covering layer facing the packaged material.

If the additive is introduced only in regions or into a layer selected for expression of activity of the packaging material or packaging (for example a covering layer or an intermediate layer situated below a covering layer), particularly large material savings are possible for the fatty acid additive, since non-supporting layers can be applied or introduced in part even from layer thickness of 0.1 or 0.2 μm. This advantage is particularly pronounced in the invention, because the fatty acid additive according to this invention, where hitherto it was possible to make measurements, is permanently active even in low concentration, since it does not migrate into the filling, or migrates only to a very small degree. It is therefore sufficient to introduce the nonstick composition of the invention into a thin layer of a multilayer film of approximately 0.1 to 5 μm.

The invention provides the use of the described packaging material for packaging foods of all types, since the relatively long fatty acid radicals surprisingly substantially prevent migration of the fatty acid ester additive from the packaging into the food, which is an important advantage compared with the prior art.

The invention also comprises food packagings which only contain one packaging material as described above in detail. Additional packaging elements, for example, made of paper or cardboard, metal clips or the like, can be present. The packaging can be filled with one or more foods.

The packaging preferably has the form of a pouch, further preferably of a tubular pouch, but it can also be a trough packaging, or any other desired plastic container or a bottle.

If the packages are produced from the thermoplastic polymers by injection molding or by extrusion, the fatty acid ester can be admixed to the polymer granules directly or in the form of a masterbatch, as is generally conventional. Depending on the packaging form, it is also possible to coat the packaging on the side facing the packaged material, that is the food, with one or more polymer sheets of which at least one contains the additive or nonstick composition of the invention.

### EXAMPLES OF THE ACTION OF THE FATTY ACID ESTER ADDITIVE

To study the action of the fatty acid ester additive, the following films were used:
Film A: Polypropylene film (20 μm) having 3000 ppm of glycerol monostearate (C18)
   comparative example
Film B: Polypropylene film (20 μm) having 3000 ppm of glycerol monobehenate (C22)
Film C: Polypropylene film (20 μm) having 1000 ppm of glycerol monobehenate (C22)

Using the above-stated films, processed cheese slices were individually wrapped. Corresponding results are found using sliced Butterkäse. The test results for the processed cheese wrapping are summarized in the table below:

| | | | | After |
|---|---|---|---|---|
| | Adhesion of the cheese | After 1 day | After 3 days | 5 days |
| Film | directly after packaging | (30° C.) | (30° C.) | (30° C.) |
| A | None | medium | strong | strong |
| B | None | none | none | none |
| C | Medium | medium | none | none |

No adhesion: On removal of the cheese slice from the film, no cheese remains on the film
Medium adhesion: On removal of the cheese slice from the film, some cheese remains on the film
Strong adhesion: The cheese slice cannot be detached in one piece from the film

It is astonishing that just a slightly longer fatty acid radical on the ester is sufficient to reduce storage sticking between the film and the cheese.

Over a plurality of months of storage time, no impairment of the detachment properties of the cheese slice from the film were observed. This means an abrupt improvement compared with the prior art.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

What is claimed is:

1. A packaging material suitable for packaging foods, comprising a thermoplastic polymer containing in at least one selected region of a fatty acid ester of a polyhydric alcohol, including at least one fatty acid radical per ester molecule having 19 carbon atoms or more, in an amount sufficient to provide an anti-stick property with respect to a packaged product.

2. A packaging material according to claim 1, wherein the fatty acid ester comprises a mono-, di- or triester of a mono-, di- or triol.

3. A packaging material according to claim 2, wherein the fatty acid ester comprises a mono- or diglycerol ester.

4. A packaging material according to claim 1, wherein the fatty acid ester comprises monoglycerol behenate.

5. A packaging material according to claim 1, wherein the fatty acid ester is present in the at least one selected region of the packaging material in a concentration greater than or equal to 200 ppm.

6. A packaging material according to claim 5, wherein the fatty acid ester is present in the at least one selected region of the packaging material in a concentration greater than or equal to 500 ppm.

7. A packaging material according to claim 6, wherein the fatty acid ester is present in the at least one selected region of the packaging material in a concentration greater than or equal to 800 ppm.

8. A packaging material according to claim 1, wherein the material is a film comprised of a polyolefin, a polyester, polystyrene, a polyamide, or a copolymer or a mixture of two or more of these polymers.

9. A packaging material according to claim 8, wherein the material is a multilayer film.

10. A packaging material according to claim 9, wherein the fatty acid ester is contained in at least one layer of the multilayer film, wherein the layer comprises polyethylene (PE), polypropylene (PP), polyethylene terephthalate (PET) or a polyamide (PA).

11. A packaging material according to claim 10, wherein the at least one layer is arranged beneath one or more covering layers of no more than in total 20 μm in thickness.

12. A packaging material according to claim 9, wherein the film is a stretched or partially stretched film.

13. A method of making a packaging material for packaging foods, comprising incorporating into at least one selected region of a polymeric packaging material a fatty acid ester of a polyhydric alcohol, including at least one fatty acid radical per ester molecule having 19 carbon atoms or more, in an amount sufficient to provide an anti-stick property with respect to a packaged product.

14. A method according to claim 13, wherein the fatty acid ester is a mono-, di- or triester of a mono-, di- or triol.

15. A method according to claim 13, wherein the fatty acid ester is incorporated into the at least one selected region of the packaging material in a concentration greater than or equal to 200 ppm.

16. A food packaging which comprises a packaging material according to claim 1.

17. A food packaging according to claim 16, having the form of a pouch, a trough packaging or a bottle.

18. A food packaging according to claim 16, wherein the fatty acid ester is contained at least in one outer layer or sheet of the packaging in the direction of the surface facing the packaged material.

19. A packaged article, comprising a food product comprising a fatty food and/or a food readily adhering to plastic surfaces, contained in a packaging material as defined according to claim 1.
